(19) United States
(12) Patent Application Publication
(10) Pub. No.: US 2024/0248230 A1
(43) Pub. Date: Jul. 25, 2024

(54) SEISMIC WELL TIE BASED ON MACHINE LEARNING

(71) Applicant: Schlumberger Technology Corporation, Sugar Land, TX (US)

(72) Inventors: Haibin Di, Houston, TX (US); Aria Abubakar, Houston, TX (US)

(21) Appl. No.: 18/564,283

(22) PCT Filed: May 26, 2022
(86) PCT No.: PCT/US2022/031109

§ 371 Date: Nov. 27, 2023

Related U.S. Application Data
(60) Provisional application No. 63/202,111, filed on May 27, 2021.

(51) Int. Cl. G01V 1/50; G06N 20/00

(52) U.S. Cl. CPC G01V 1/50; G06N 20/00; G01V 2210/74

(57) ABSTRACT

A method includes obtaining a synthetic seismogram representing a seismic well tie, a shifted synthetic seismogram representing the seismic well tie, and a shift input including domain shift data for converting well log data from a depth domain to a time domain, generating a shift label based on the synthetic seismogram and the shifted synthetic seismogram using a machine learning model, determining that an accuracy of the shift label is less than a threshold based on a comparison of the shift input and the shift label, adjusting the machine learning model in response to determining that the accuracy of the shift label is less than the threshold, predicting a second shift for a second seismic well tie from a second seismogram using the machine learning model, and generating a seismic image based on the second seismic well tie, the second seismogram, and the second shift.

### CROSS-REFERENCE TO RELATED APPLICATIONS

This application claims priority to U.S. Provisional Patent Application having Ser. No. 63/202,111, which was filed on May 27, 2021 and is incorporated herein by reference in its entirety.

### BACKGROUND

Seismic well ties provide a link between subsurface properties directly measured at a wellbore and data obtained through seismic sounding. Well logs are measured in a depth domain and seismic data is measured in a time domain; therefore, a depth-time conversion relationship is determined to perform conversions between the domains. Methods of determining the depth-time conversion relationship include, but are not limited to, checkshot surveying and vertical seismic profiling (VSP). When checkshots and a VSP are not available, the depth-time conversion relationship can be computed using sonic measurements from well logging.

Seismic well ties can have varying quality. Any mis-ties can be adjusted by extensive manual stretching and squeezing of well logs, which adjust the depth-time conversion relationship. However, the extensive manual stretching and squeezing of well logs is a time-consuming process.

### SUMMARY

A method is disclosed, which includes obtaining a synthetic seismogram representing a seismic well tie, a shifted synthetic seismogram representing the seismic well tie, and a shift input including domain shift data for converting well log data from a depth domain to a time domain, generating a shift label based on the synthetic seismogram and the shifted synthetic seismogram using a machine learning model, the shift label including domain shift data for converting well log data from a depth domain to a time domain, determining that an accuracy of the shift label is less than a threshold based on a comparison of the shift input and the shift label, adjusting the machine learning model in response to determining that the accuracy of the shift label is less than the threshold, predicting a second shift for a second seismic well tie from a second seismogram using the machine learning model, and generating a seismic image based on the second seismic well tie, the second seismogram, and the second shift.

A computing system is disclosed, which includes one or more processors and a memory including one or more non-transitory computer-readable media storing instructions that, when executed by at least one of the one or more processors, cause the computing system to perform operations. The operations include obtaining a synthetic seismogram representing a seismic well tie, a shifted synthetic seismogram representing the seismic well tie, and a shift input including domain shift data for converting well log data from a depth domain to a time domain, generating a shift label based on the synthetic seismogram and the shifted synthetic seismogram using a machine learning model, the shift label including domain shift data for converting well log data from a depth domain to a time domain, determining that an accuracy of the shift label is less than a threshold based on a comparison of the shift input and the shift label, adjusting the machine learning model in response to determining that the accuracy of the shift label is less than the threshold, predicting a second shift for a second seismic well tie from a second seismogram using the machine learning model, and generating a seismic image based on the second seismic well tie, the second seismogram, and the second shift.

A non-transitory computer-readable medium is disclosed, which stores instructions that, when executed by at least one processor of a computing system, cause the computing system to perform operations. The operations include obtaining a synthetic seismogram representing a seismic well tie, a shifted synthetic seismogram representing the seismic well tie, and a shift input including domain shift data for converting well log data from a depth domain to a time domain, generating a shift label based on the synthetic seismogram and the shifted synthetic seismogram using a machine learning model, the shift label including domain shift data for converting well log data from a depth domain to a time domain, determining that an accuracy of the shift label is less than a threshold based on a comparison of the shift input and the shift label, adjusting the machine learning model in response to determining that the accuracy of the shift label is less than the threshold, predicting a second shift for a second seismic well tie from a second seismogram using the machine learning model, and generating a seismic image based on the second seismic well tie, the second seismogram, and the second shift.

Thus, the computing systems and methods disclosed herein are more effective methods for processing collected data that may, for example, correspond to a surface and a subsurface region. These computing systems and methods increase data processing effectiveness, efficiency, and accuracy. Such methods and computing systems may complement or replace conventional methods for processing collected data. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates an example environment for training a machine learning model to predict a shift for a seismic well tie.

FIG. 5 is a functional block diagram of an example computing system, which may implement various embodiments.

FIG. 6 illustrates an example workflow according to various embodiments.

FIGS. 7 and 8 are flowcharts of an example process for training a machine learning model to produce shift labels corresponding to a predicted shift for a seismic well tie.

FIG. 9 is a flowchart of an example process for validating a trained machine learning model according to embodiments.

FIG. 10 is a flowchart of an example process for applying a synthetic seismogram and a corresponding real seismogram to a trained machine learning model to predict a shift for a seismic well tie, update a depth-time conversion relationship, and generate a shifted synthetic seismogram based on the updated depth-time conversion relationship.

FIGS. 11A, 11B, and 11C illustrate a flowchart of a method, according to an embodiment.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of embodiments of the invention, according to an embodiment. However, it will be apparent to one of ordinary skill in the art that embodiments of the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the invention. The first object and the second object are both objects, respectively, but they are not to be considered the same object.

The terminology used in the description of embodiments of the invention herein is for the purpose of describing particular embodiments only and is not intended to be limiting of the invention. As used in the description of embodiments of the invention and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

Although the following description refers generally to oilfield operations, it will be appreciated that embodiments of the present invention are not so narrowly confined. Rather, at least some embodiments may be used in any setting for which subterranean imaging may be useful, e.g., geothermal energy production facilities, wind farms, solar arrays, or any other construction operation, whether subsurface or above-ground. Thus, it will be appreciated that the following discussion of an oilfield context is merely an example.

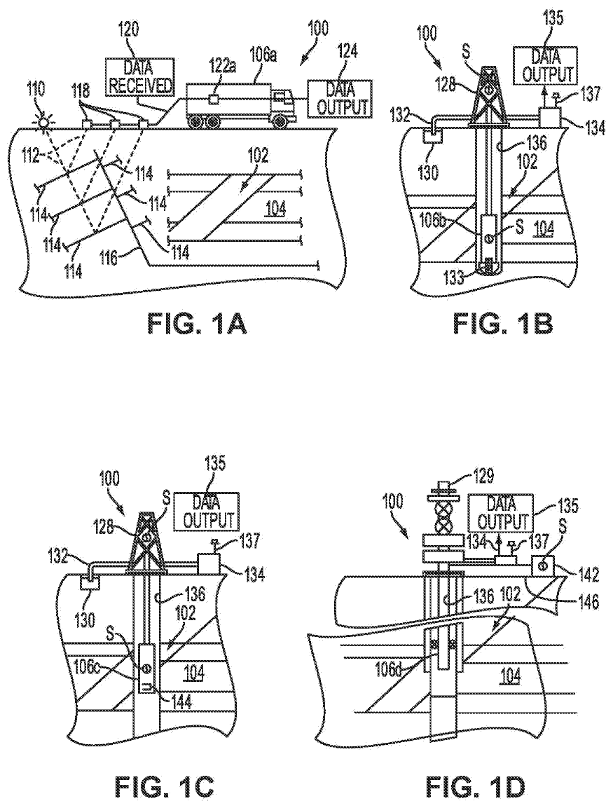

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106a, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122a of a seismic truck 106a, and responsive to the input data, computer 122a generates seismic data output 124. This seismic data output may be stored, transmitted or further processed as desired, for example, by data reduction.

FIG. 1B illustrates a drilling operation being performed by drilling tools 106b suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106b may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106c suspended by rig 128 and into wellbore 136 of FIG. 1B. Wireline tool 106c is adapted for deployment into wellbore 136 for generating well logs, performing downhole tests and/or collecting samples. Wireline tool 106c may be used to provide another method and apparatus for performing a seismic survey operation. Wireline tool 106c may, for example, have an explosive, radioactive, electrical, or acoustic energy source 144 that sends and/or receives electrical signals to surrounding subterranean formations 102 and fluids therein.

Wireline tool 106c may be operatively connected to, for example, geophones 118 and a computer 122a of a seismic truck 106a of FIG. 1A. Wireline tool 106c may also provide data to surface unit 134. Surface unit 134 may collect data generated during the wireline operation and may produce data output 135 that may be stored or transmitted. Wireline tool 106c may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106c to measure downhole parameters which relate to, for example porosity, permeability, fluid composition and/or other parameters of the field operation.

FIG. 1D illustrates a production operation being performed by production tool 106d deployed from a production unit or Christmas tree 129 and into completed wellbore 136 for drawing fluid from the downhole reservoirs into surface facilities 142. The fluid flows from reservoir 104 through perforations in the casing (not shown) and into production tool 106d in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106d or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

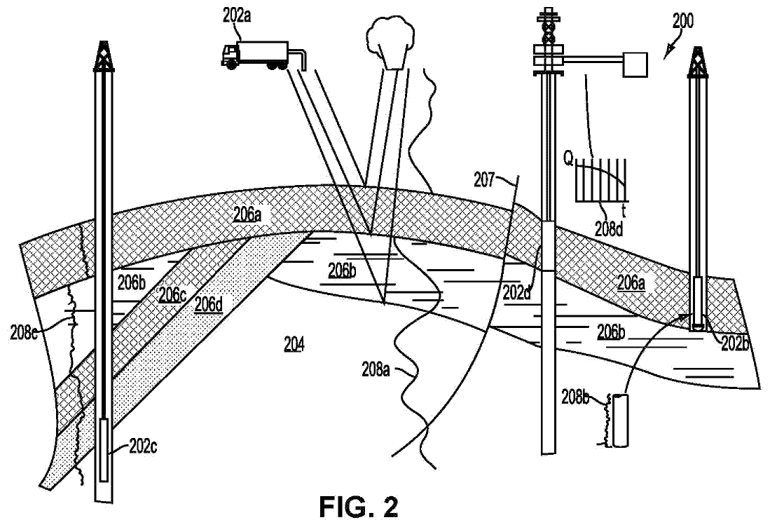

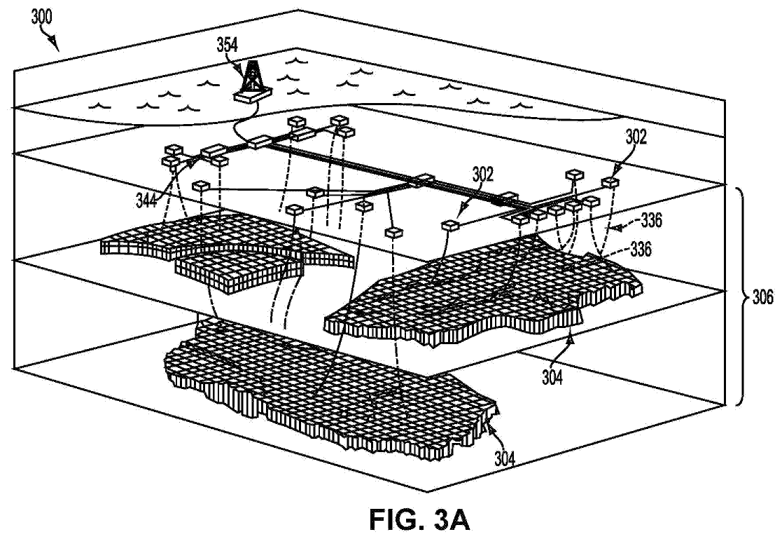

FIG. 2 illustrates a schematic view, partially in cross section of oilfield 200 having data acquisition tools 202a, 202b, 202c and 202d positioned at various locations along oilfield 200 for collecting data of subterranean formation 204 in accordance with implementations of various technologies and techniques described herein. Data acquisition tools 202a-202d may be the same as data acquisition tools 106a-106d of FIGS. 1A-1D, respectively, or others not depicted. As shown, data acquisition tools 202a-202d generate data plots or measurements 208a-208d, respectively. These data plots are depicted along oilfield 200 to demonstrate the data generated by the various operations.

Data plots 208a-208c are examples of static data plots that may be generated by data acquisition tools 202a-202c, respectively; however, it should be understood that data plots 208a-208c may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208a is a seismic two-way response over a period of time. Static plot 208b is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208c is a logging trace that typically provides a resistivity or other measurement of the formation at various depths.

A production decline curve or graph 208d is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206a-206d. As shown, this structure has several formations or layers, including a shale layer 206a, a carbonate layer 206b, a shale layer 206c and a sand layer 206d. A fault 207 extends through the shale layer 206a and the carbonate layer 206b. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208a from data acquisition tool 202a is used by a geophysicist to determine characteristics of the subterranean formations and features. The core data shown in static plot 208b and/or log data from well log 208c are typically used by a geologist to determine various characteristics of the subterranean formation. The production data from graph 208d is typically used by the reservoir engineer to determine fluid flow reservoir characteristics. The data analyzed by the geologist, geophysicist and the reservoir engineer may be analyzed using modeling techniques.

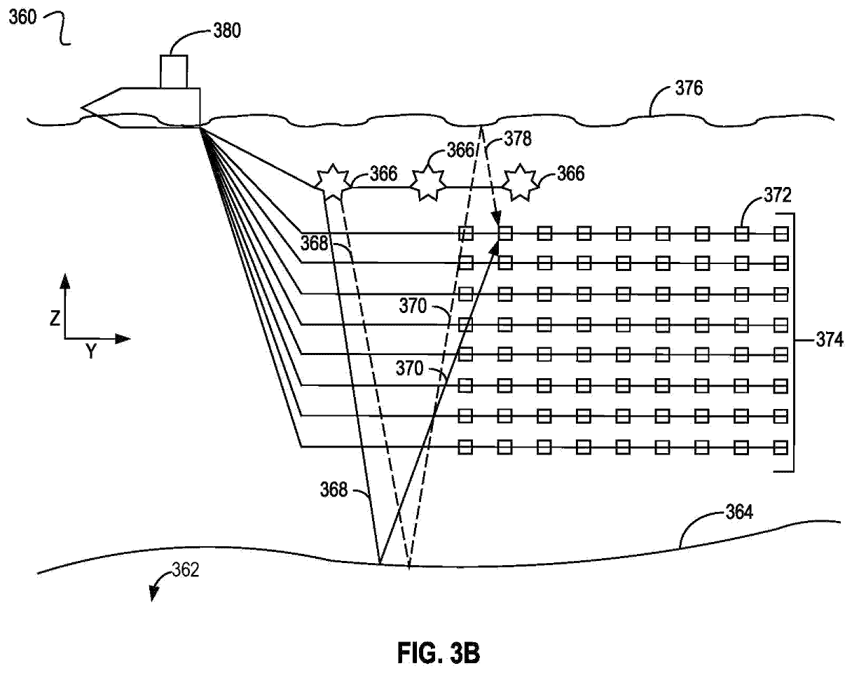

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the Earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

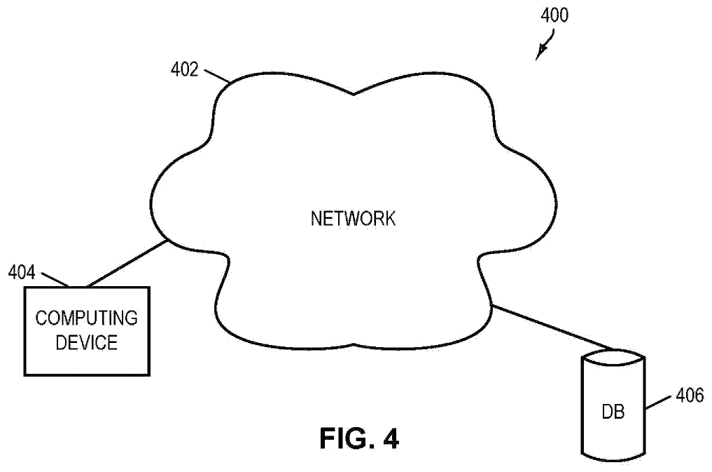

FIG. 4 illustrates an example environment 400 for training a machine learning model to predict a shift from a synthetic seismogram, based on well log data, for a seismic well tie. Environment 400 may include a network 402, a computing device 404 connected to network 402, and a database 406 connected to network 402. Computing device 404 and database 406 may be connected to network 402 via a wired connection or a wireless connection using, for example, Wi-Fi and/or satellite communications. Alternatively, database 406 may be directly connected to computing device 404 in some embodiments.

Network 402 may be a wired or wireless network and may be implemented by any number of suitable communication media such as, for example, a packet-switched data network (PSDN), a radio frequency network, a satellite communication network, a network of networks such as the Internet, a company intranet, other types of networks, or a combination of various types of networks.

Database 406 may include training data including, but not limited to, data from well logs, corresponding synthetic seismograms, shift input, shifted synthetic seismograms, and at least initial data-time conversion relationships. Database 406 may further include verification data to be used for verifying a trained machine learning model. The verification data may include, but not be limited to, well logs, corresponding synthetic seismograms, shift input, shifted synthetic seismograms, etc.

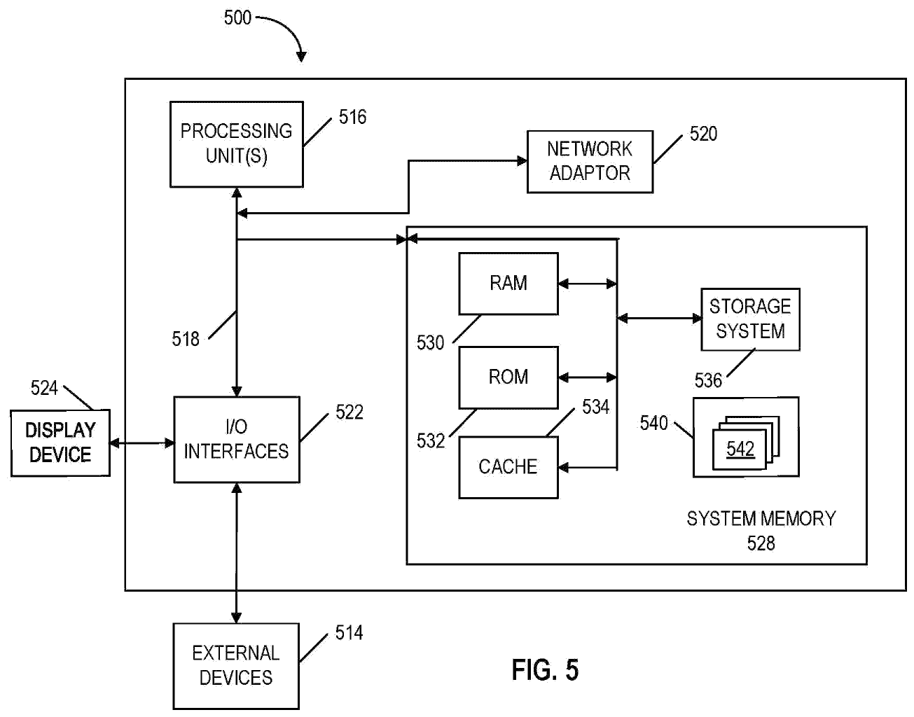

FIG. 5 is a functional block diagram of a computing system 500 that may be used to implement computing device 404 according to various embodiments. Computing system 500 is shown in a form of a general-purpose computing device. Components of computing system 500 may include, but are not limited to, one or more processing units 516, a system memory 528, and a bus 518 that couples various system components including system memory 528 to one or more processing units 516.

Bus 518 represents any one or more of several bus structure types, including a memory bus or memory controller, a peripheral bus, an accelerated graphics port, and a processor or local bus using any of a variety of bus architectures. Such architectures may include, but not be limited to, Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computing system 500 may include various computer system readable media, which may be any available non-transitory media accessible by computing system 500. The computer system readable media may include volatile and non-volatile media as well as removable and non-removable media.

System memory 528 may include non-transitory volatile memory, such as random access memory (RAM) 530 and cache memory 534. System memory 528 also may include non-transitory non-volatile memory including, but not limited to, read-only memory (ROM) 532 and storage system 536. Storage system 536 may be provided for reading from and writing to a non-removable, non-volatile magnetic medium, which may include a hard drive or a Secure Digital (SD) card. In addition, a magnetic disk drive, not shown, may be provided for reading from and writing to a removable, non-volatile magnetic disk such as, for example, a floppy disk, and an optical disk drive for reading from or writing to a removable non-volatile optical disk such as a CD-ROM, DVD-ROM or other optical media. Each memory device may be connected to bus 518 by at least one data media interface. System memory 528 further may include instructions for processing unit(s) 516 to configure computing system 500 to perform functions of embodiments of the invention. For example, system memory 528 also may include, but not be limited to, processor instructions for an operating system, at least one application program, other program modules, program data, and an implementation of a networking environment.

Computing system 500 may communicate with one or more external devices 514 including, but not limited to, one or more displays, a keyboard, a pointing device, a speaker, at least one device that enables a user to interact with computing system 500, and any devices including, but not limited to, a network card, modem, etc. that enable computing system 500 to communicate with one or more other computing devices. The communication can occur via Input/Output (I/O) interfaces 522. Computing system 500 can communicate with one or more networks including, but not limited to, a local area network (LAN), a general wide area network (WAN), a packet-switched data network (PSDN) and/or a public network such as, for example, the Internet, via network adapter 520. As depicted, network adapter 520 communicates with the other components of computer system 500 via bus 518.

It should be understood that, although not shown, other hardware and/or software components could be used in conjunction with computer system 500. Examples, include, but are not limited to, microcode, device drivers, redundant processing units, external disk drive arrays, RAID systems, tape drives, and data archival storage systems, etc.

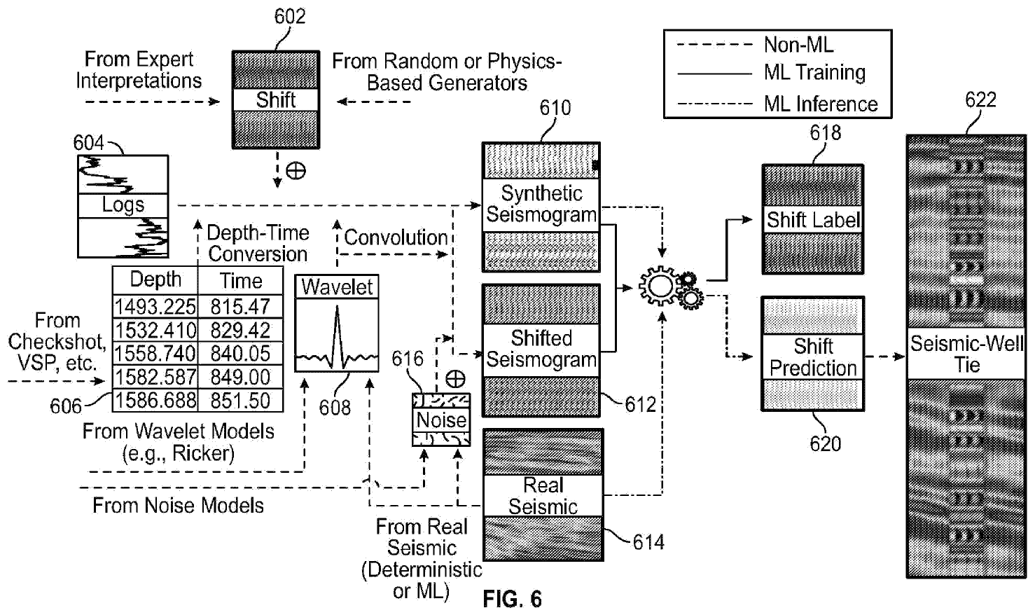

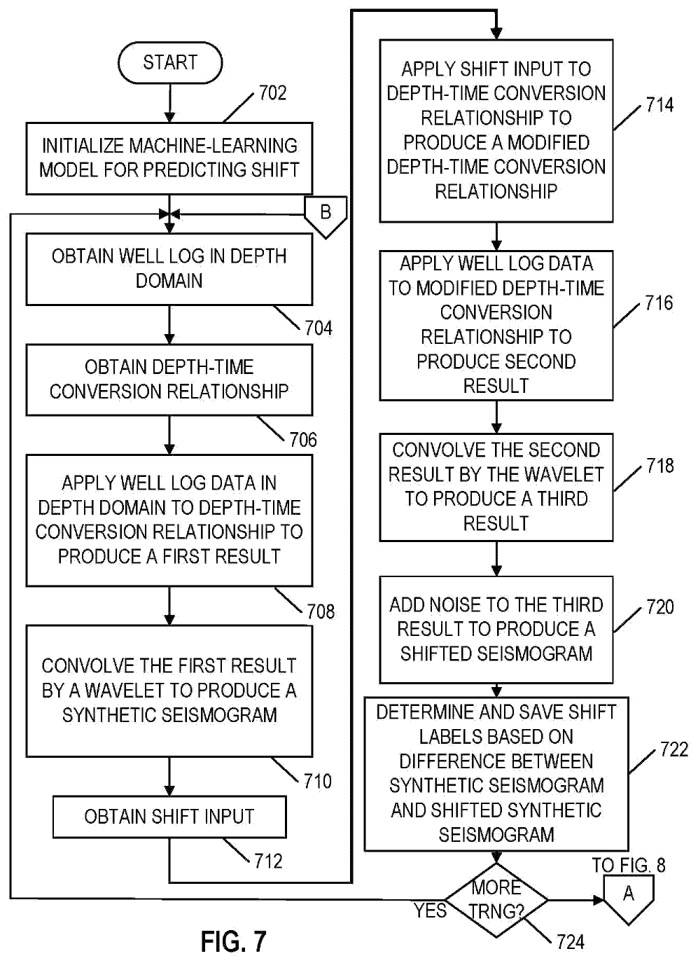

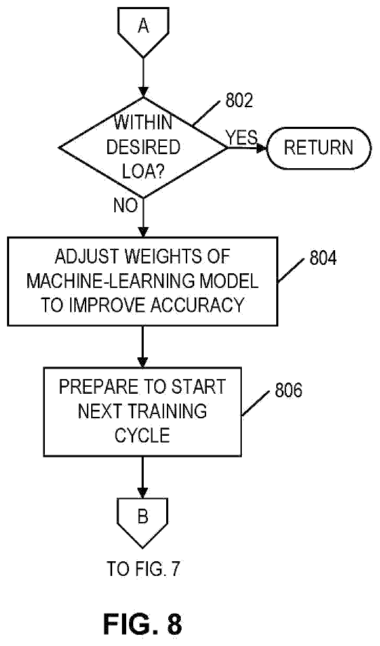

FIGS. 7 and 8, with reference to an example workflow of FIG. 6, illustrate an example training process for training a machine learning model to predict a shift for a seismic well tie. Although the workflow presents the acts in a particular order, it will be appreciated that the acts may be performed in any order, without departing from the scope of the present disclosure. Further, certain of the acts may be combined, or individual acts may be partitioned into two or more, consistent with the present disclosure.

The training process may begin with computing device 404 initializing weights for a machine learning model for predicting a shift (act 702). The machine learning model may include a convolutional neural network (CNN), a recurrent neural network (RNN), or another type of machine learning model. Next, computing device 404 may obtain well log data 604 in a depth domain from database 406 (act 704). Computing device 404 then may obtain a depth-time conversion relationship 606 from database 106 (act 706). Depth-time conversion relationship 606 may have been obtained from a checkshot via a vertical seismic profile (VSP) or may be computed using sonic measurements from well logging.

Computing device 404 may apply well log data 604 in the depth domain to depth-time conversion relationship 606 to produce a first result (act 708), which may be convolved by a wavelet 608 to produce a synthetic seismogram 610 in a depth domain (act 710). In some embodiments, the wavelet may be a Ricker wavelet. In other embodiments, the wavelet may have been extracted from a corresponding real seismogram using a deterministic approach including, but not limited to, autocorrelation, or may be learned by training a machine learning model to predict a wavelet based on seismic characteristics such as, for example, frequency.

Next, shift input 602 may be obtained from database 406 and computing device 404 may apply the shift input to depth-time conversion relationship 606 to modify depth-time conversion relationship (act 714). Shift input 602 may be human-generated, at least in part, e.g., provided by expert interpretations of synthetic seismogram 610 with respect to a corresponding real seismogram and/or shifted synthetic seismogram 612 based on, for example, a random or a physics based generator.

Well log data 602 may be applied to modified depth-time conversion relationship 606 to produce a second result (act 716). The second result may be convolved by wavelet 608 to produce a third result (act 718). The third result may be a shifted synthetic seismogram 612 in some embodiments and may include shift labels indicating amounts of predicted shift at specific times.

In other embodiments, noise 616 may be added to the third result to produce shifted synthetic seismogram 612 (act 720). Noise 616 may be a provided noise model or may be provided by a trained machine learning model for predicting noise based on a corresponding real seismogram. Adding noise 616 to the third result produces shifted synthetic seismogram 612, which may be more similar to real seismic 614 than shifted seismogram 612 produced without adding noise 616.

Computing device 404 may determine shift labels 618 based on a differences between synthetic seismogram 610 and shifted synthetic seismogram 612 and may save the shift labels 616 (act 722). Computing device 404 then may determine whether additional training data (TRNG) exists (act 724). If additional training data is determined to exist then acts 704-724 again may be performed. Otherwise, computing device 404 may determine whether produced shift labels 618 are within a desired level of accuracy (LOA) of provided shift input 602 (act 802; FIG. 8). If produced shift labels 618 are not within the desired level of accuracy, then computing device 404 may adjust weights of the machine learning model to improve the accuracy (act 804). In various embodiments, the adjusted weights may be determined by backpropagation.

Computing device 404 then may prepare to start a next cycle of training with the weight-adjusted machine learning model (act 806) by repeating acts 704-806 until the desired level of accuracy is achieved.

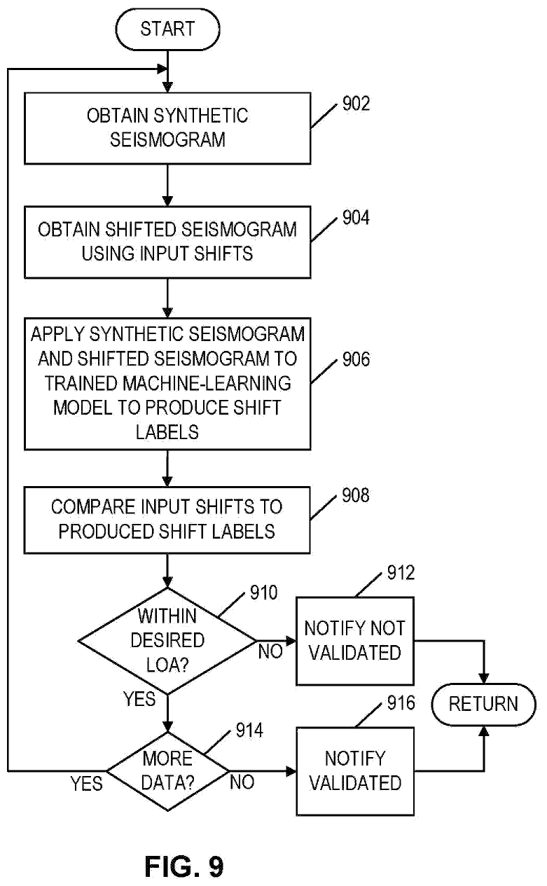

Next, computing device 404 may validate a trained machine learning model using validation data, which may be different from the training data, but in a same format as the training data according to embodiments. FIG. 9, with reference to the workflow of FIG. 6, is a flowchart of an example process for validating a trained machine learning model for predicting a shift with respect to a synthetic seismogram to produce a shifted synthetic seismogram within a desired level of accuracy of a corresponding real seismic. Although the process is described including acts performed in a particular order, it will be appreciated that the acts may be performed in any order, without departing from the scope of the present disclosure. Further, certain of the acts may be combined, or individual acts may be partitioned into two or more, consistent with the present disclosure.

The process may begin by obtaining synthetic seismogram 610 corresponding to well log data 604 (act 902). Act 902 may include performing acts that may be identical to acts 704-710, but using the validation data instead of the training data.

Computing device 404 then may obtain shifted synthetic seismogram 612 (act 904) by performing acts that may be identical to acts 712-722, but using the validation data instead of the training data. Computing device 404 may apply the obtained synthetic seismogram 610 and shifted synthetic seismogram 612 to the trained machine learning model to produce shift labels 618. Shift input 602 of the validation data then may be compared with produced shift labels 618 (act 908). If produced shift labels 618 are determined not to be within a desired level act of accuracy (e.g., above a threshold accuracy, which includes a determination of being below a threshold error amount) of shift input 602 (act 910), then a notification may be provided indicating that the trained machine learning model is not validated (act 912). The notification may be provided on a display of computing device 404, on a printed report, in a created file, via an email sent to a specific email address, via a short message service (SMS) message to a specific mobile phone number, via a speaker using recorded or computer-generated speech, or via other methods. The process then may be completed.

If, during act 910, produced shift labels 618 are within the desired level of accuracy, then a determination may be made regarding whether additional validation data exists (act 914). If the additional validation data is determined to exist, then 902-910 may be repeated with the additional validation data. Otherwise, a notification indicating that the trained machine learning model is validated may be provided in a same manner as mentioned with respect to act 912 (act 916) and the process may be completed.

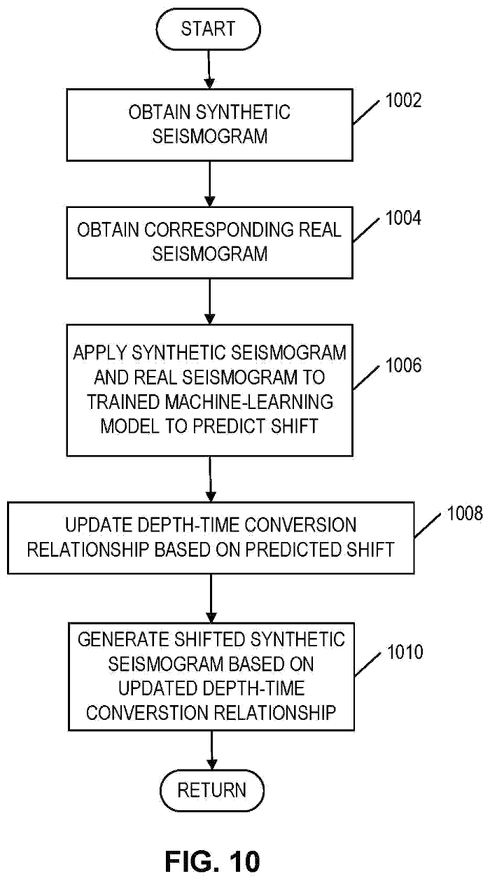

FIG. 10 is a flowchart illustrating an example process for using the trained machine learning model to predict a shift from a synthetic seismogram 610 to a real seismic 614 according to a seismic well tie. The process may begin by computing device 404 obtaining synthetic seismogram 610 based on well log data 604 (act 1002). Synthetic seismogram 610 may be previously generated or may be generated by performing acts including acts identical to acts 704-710 using well log data 602, depth-time conversion relationship 606, and wavelet 608. Computing device 404 may obtain a corresponding real seismic or seismogram 614 (act 1004) and may apply synthetic seismogram 610 and corresponding real seismic or seismogram 614 to the trained machine learning model to make a shift prediction 620 for seismic well tie 622 (act 1006). Computing device 404 may update depth-time conversion relationship 606 based on shift prediction 620 (act 1008) and may generate shifted synthetic seismogram 612 having a seismic well tie to real seismic or seismogram 614 within the desired level of accuracy used to train the machine learning model (act 1010).

Although computing device 404 is described as performing processing as indicated by the flowchart of FIG. 10, another computing device may perform the processing indicated by the flowchart of FIG. 10 such as, for example, computer 122a on seismic truck 106a, or another computing device.

In some embodiments, a model such as, for example, a velocity model, a visual model, or another type of model, may be created based on a seismic well tie and a seismic image may be generated based, at least in part, on the created model. Further, being able to predict a better seismic well tie more efficiently allows for generation of a more efficient and better seismic image and model of a subsurface domain. In turn, such enhanced models and images can provide visual and/or other information to well planners, drillers, and/or other operators, which may be used to adjust trajectories, equipment parameters, or take adjust any other physical operating parameter of a machine, e.g., a drilling rig, construction equipment, etc.

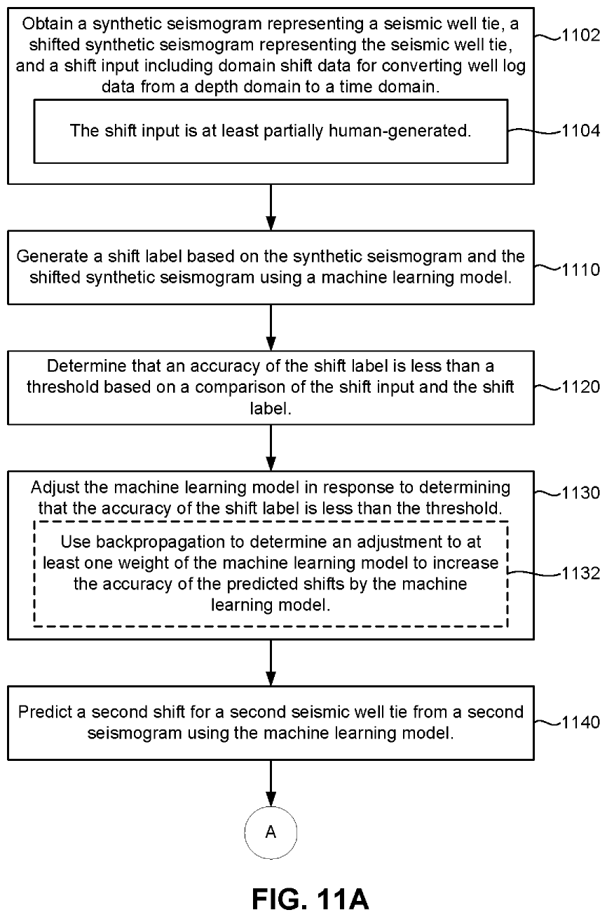

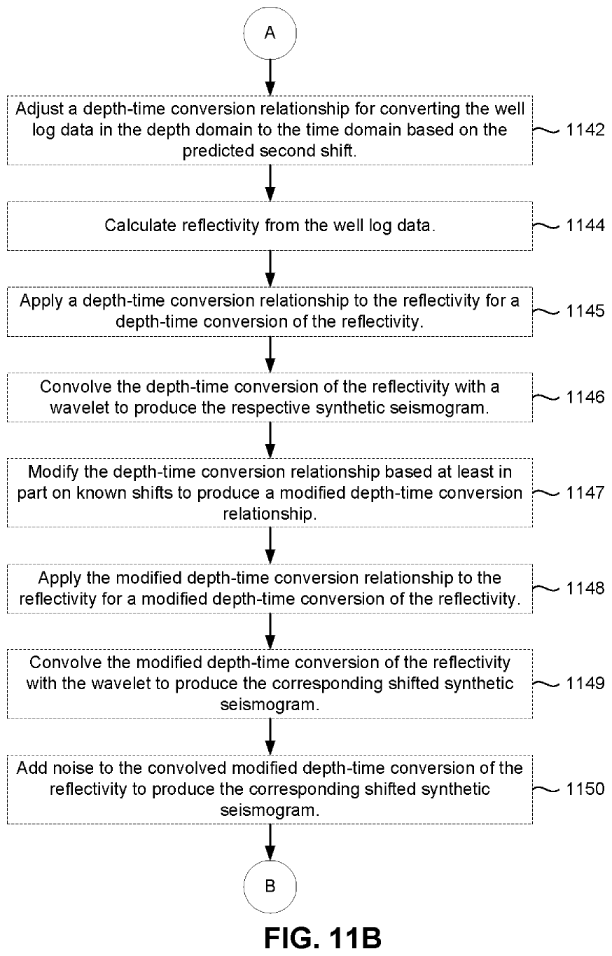

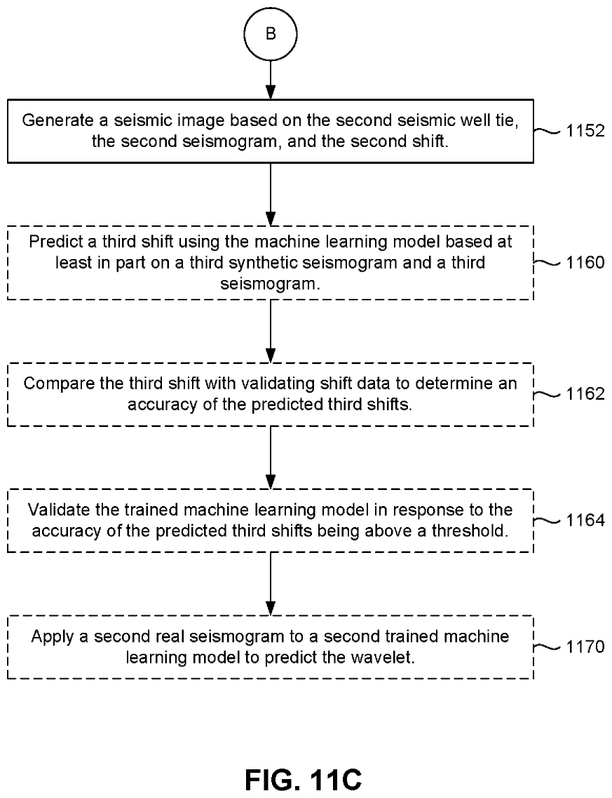

FIGS. 11A-11C illustrate a flowchart of a method 1100, according to an embodiment. The method 1100 includes obtaining a synthetic seismogram representing a seismic well tie, a shifted synthetic seismogram representing the seismic well tie, and a shift input including domain shift data for converting well log data from a depth domain to a time domain, as at 1102 (e.g., FIGS. 7, 702, 704, and 706). In at least some embodiments, the shift input is at least partially human-generated, as at 1104.

The method 1100 also includes generating a shift label based on the synthetic seismogram and the shifted synthetic seismogram using a machine learning model, as at 1110 (e.g., FIG. 7, 708). The shift label includes domain shift data for converting well log data from a depth domain to a time domain.

The method 1100 includes determining that an accuracy of the shift label is less than a threshold based on a comparison of the shift input and the shift label, as at 1120 (e.g., FIG. 8, 802).

The method 1100 includes adjusting the machine learning model in response to determining that the accuracy of the shift label is less than the threshold, as at 1130 (e.g., FIG. 8, 804). In an embodiment, adjusting the machine learning model includes using backpropagation to determine an adjustment to at least one weight of the machine learning model to increase the accuracy of the predicted shifts by the machine learning model, as at 1132.

The method 1100 includes predicting a second shift for a second seismic well tie from a second seismogram using the machine learning model, as at 1140 (e.g., FIG. 9, 906).

In at least some embodiments, the method 1100 includes adjusting a depth-time conversion relationship for converting the well log data in the depth domain to the time domain based on the predicted second shift, as at 1142 (e.g., FIG. 10, 1008).

In at least some embodiments, the method 1100 also includes calculating reflectivity from the well log data, as at 1144 (e.g., FIG. 10, 1010). The method 1100 also includes applying a depth-time conversion relationship to the reflectivity for a depth-time conversion of the reflectivity, as at 1145 (e.g., FIG. 10, 1010). The method 1100 also includes convolving the depth-time conversion of the reflectivity with a wavelet to produce the respective synthetic seismogram, as at 1146 (e.g., FIG. 10, 1010). The method 1100 further includes modifying the depth-time conversion relationship based at least in part on known shifts to produce a modified depth-time conversion relationship, as at 1147 (e.g., FIG. 10, 1010). The method 1100 includes applying the modified depth-time conversion relationship to the reflectivity for a modified depth-time conversion of the reflectivity, as at 1148 (e.g., FIG. 10, 1010). The method 1100 includes convolving the modified depth-time conversion of the reflectivity with the wavelet to produce the corresponding shifted synthetic seismogram, as at 1149 (e.g., FIG. 10, 1010). The method 1100 further includes adding noise to the convolved modified depth-time conversion of the reflectivity to produce the corresponding shifted synthetic seismogram, as at 1150 (e.g., FIG. 10, 1010).

The method 1100 includes generating a seismic image based on the second seismic well tie, the second seismogram, and the second shift, as at 1152.

The method 1100 may also include predicting a third shift using the machine learning model based at least in part on a third synthetic seismogram and a third seismogram, as at 1160 (e.g., FIG. 9, 904). The method 1100 may also include comparing the third shift with validating shift data to determine an accuracy of the predicted third shifts, as at 1162 (e.g., FIG. 9, 910). The method 1100 may further include validating the trained machine learning model in response to the accuracy of the predicted third shifts being above a threshold, as at 1164 (e.g., FIG. 9, 916).

In at least some embodiments, the method 1100 includes applying a second real seismogram to a second trained machine learning model to predict the wavelet, as at 1170 (e.g., FIG. 10, 1006).

In one or more embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

Further, the steps in the processing methods described herein may be implemented by running one or more functional modules in information processing apparatus such as general purpose processors or application specific chips, such as ASICs, FPGAS, PLDs, or other appropriate devices. These modules, combinations of these modules, and/or their combination with general hardware are all included within the scope of protection of the invention.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 700, FIG. 7), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
obtaining a synthetic seismogram representing a seismic well tie, a shifted synthetic seismogram representing the seismic well tie, and a shift input including domain shift data for converting well log data from a depth domain to a time domain;
generating a shift label based on the synthetic seismogram and the shifted synthetic seismogram using a machine learning model, wherein the shift label includes domain shift data for converting well log data from a depth domain to a time domain;
determining that an accuracy of the shift label is less than a threshold based on a comparison of the shift input and the shift label;
adjusting the machine learning model in response to determining that the accuracy of the shift label is less than the threshold;
predicting a second shift for a second seismic well tie from a second seismogram using the machine learning model; and
generating a seismic image based on the second seismic well tie, the second seismogram, and the second shift.

2. The method of claim 1, wherein adjusting the machine learning model includes using backpropagation to determine an adjustment to at least one weight of the machine learning model to increase the accuracy of the predicted shifts by the machine learning model.

3. The method of claim 1, comprising:
predicting a third shift using the machine learning model based at least in part on a third synthetic seismogram and a third seismogram;
comparing the third shift with validating shift data to determine an accuracy of the predicted third shifts; and
validating the trained machine learning model in response to the accuracy of the predicted third shifts being above a threshold.

4. The method of claim 1, wherein the shift input is at least partially human-generated.

5. The method of claim 1, comprising adjusting a depth-time conversion relationship for converting the well log data in the depth domain to the time domain based on the predicted second shift.

6. The method of claim 1, comprising:
calculating reflectivity from the well log data;
applying a depth-time conversion relationship to the reflectivity for a depth-time conversion of the reflectivity;
convolving the depth-time conversion of the reflectivity with a wavelet to produce the respective synthetic seismogram;
modifying the depth-time conversion relationship based at least in part on known shifts to produce a modified depth-time conversion relationship;
applying the modified depth-time conversion relationship to the reflectivity for a modified depth-time conversion of the reflectivity; and
convolving the modified depth-time conversion of the reflectivity with the wavelet to produce the corresponding shifted synthetic seismogram.

7. The method of claim 6, further comprising applying a second real seismogram to a second trained machine learning model to predict the wavelet.

8. The method of claim 6, further comprising adding noise to the convolved modified depth-time conversion of the reflectivity to produce the corresponding shifted synthetic seismogram.

9. A computing system, comprising:
one or more processors; and
a memory including one or more non-transitory computer-readable media storing instructions that, when executed by at least one of the one or more processors, cause the computing system to perform operations, the operations comprising:
obtaining a synthetic seismogram representing a seismic well tie, a shifted synthetic seismogram representing the seismic well tie, and a shift input including domain shift data for converting well log data from a depth domain to a time domain;
generating a shift label based on the synthetic seismogram and the shifted synthetic seismogram using a machine learning model, wherein the shift label includes domain shift data for converting well log data from a depth domain to a time domain;
determining that an accuracy of the shift label is less than a threshold based on a comparison of the shift input and the shift label;
adjusting the machine learning model in response to determining that the accuracy of the shift label is less than the threshold;
predicting a second shift for a second seismic well tie from a second seismogram using the machine learning model; and
generating a seismic image based on the second seismic well tie, the second seismogram, and the second shift.

10. The system of claim 9, wherein adjusting the machine learning model includes using backpropagation to determine an adjustment to at least one weight of the machine learning model to increase the accuracy of the predicted shifts by the machine learning model.

11. The system of claim 9, wherein the operations include:
predicting a third shift using the machine learning model based at least in part on a third synthetic seismogram and a third seismogram;
comparing the third shift with validating shift data to determine an accuracy of the predicted third shifts; and
validating the trained machine learning model in response to the accuracy of the predicted third shifts being above a threshold.

12. The system of claim 9, wherein the shift input is at least partially human-generated.

13. The system of claim 9, wherein the operations further include adjusting a depth-time conversion relationship for converting the well log data in the depth domain to the time domain based on the predicted second shift.

14. The system of claim 9, wherein the operations include:
calculating reflectivity from the well log data;
applying a depth-time conversion relationship to the reflectivity for a depth-time conversion of the reflectivity;
convolving the depth-time conversion of the reflectivity with a wavelet to produce the respective synthetic seismogram;
modifying the depth-time conversion relationship based at least in part on known shifts to produce a modified depth-time conversion relationship;
applying the modified depth-time conversion relationship to the reflectivity for a modified depth-time conversion of the reflectivity; and
convolving the modified depth-time conversion of the reflectivity with the wavelet to produce the corresponding shifted synthetic seismogram.

15. The system of claim 14, wherein the operations further include applying a second real seismogram to a second trained machine learning model to predict the wavelet.

16. The system of claim 14, wherein the operations further include adding noise to the convolved modified depth-time conversion of the reflectivity to produce the corresponding shifted synthetic seismogram.

17. A non-transitory computer-readable medium storing instructions that, when executed by at least one processor of a computing system, cause the computing system to perform operations, the operations comprising:
obtaining a synthetic seismogram representing a seismic well tie, a shifted synthetic seismogram representing the seismic well tie, and a shift input including domain shift data for converting well log data from a depth domain to a time domain;
generating a shift label based on the synthetic seismogram and the shifted synthetic seismogram using a machine learning model, wherein the shift label includes domain shift data for converting well log data from a depth domain to a time domain;
determining that an accuracy of the shift label is less than a threshold based on a comparison of the shift input and the shift label;
adjusting the machine learning model in response to determining that the accuracy of the shift label is less than the threshold;
predicting a second shift for a second seismic well tie from a second seismogram using the machine learning model; and
generating a seismic image based on the second seismic well tie, the second seismogram, and the second shift.

18. The medium of claim 17, wherein adjusting the machine learning model includes using backpropagation to determine an adjustment to at least one weight of the machine learning model to increase the accuracy of the predicted shifts by the machine learning model.

19. The medium of claim 17, wherein the operations further include:
predicting a third shift using the machine learning model based at least in part on a third synthetic seismogram and a third seismogram;
comparing the third shift with validating shift data to determine an accuracy of the predicted third shifts; and
validating the trained machine learning model in response to the accuracy of the predicted third shifts being above a threshold.

20. The medium of claim 17, wherein the operations further include adjusting a depth-time conversion relationship for converting the well log data in the depth domain to the time domain based on the predicted second shift.
